(19) United States
(12) Patent Application Publication
(10) Pub. No.: US 2020/0198022 A1
(43) Pub. Date: Jun. 25, 2020

(54) WHEEL RIM CHUCK WITH SOFT JAWS

(71) Applicant: TOP-ONE MACHINERY CO., LTD., Taichung City (TW)

(72) Inventor: Tsui-O LIU, Taichung City (TW)

(21) Appl. No.: 16/226,447

(22) Filed: Dec. 19, 2018

(51) Int. Cl. B23B 31/163; G01M 17/02

(52) U.S. Cl. CPC B23B 31/16008; B23B 2222/04; B23B 2228/28; G01M 17/021

(57) ABSTRACT

A wheel rim chuck has a chuck seat (10) and multiple soft jaws (20). The soft jaws are arranged radially at equiangular intervals and slidably mounted on the chuck seat (10). Each soft jaw (20) has a claw (21) having a protrusion (211), a clamping groove (213), and an inclined plane (216). The protrusion (211) protrudes from a side of the soft jaw (20) away from the chuck seat (10). The clamping groove (213) is recessed in a side of the protrusion (211) facing the center (111) of the chuck seat (10) and having a side wall (214) and a bottom wall (215). The inclined plane (216) extends longitudinally and obliquely from the bottom wall (215) away from the side wall (214) of the clamping groove (213).

### BACKGROUND OF THE INVENTION

### 1. Field of the Invention

The present invention relates to a chuck for clamping a wheel rim, and more particularly to a wheel rim chuck with soft jaws to move the wheel rim into clamping grooves without adjusting a position of the wheel rim.

### 2. Description of Related Art

With reference to FIGS. 9 and 10, a conventional chuck for clamping a wheel rim substantially has a chuck seat 80 and multiple soft jaws 90. The soft jaws 90 are arranged radially at equiangular intervals and slidably mounted on the chuck seat 80. Each soft jaw 90 has at least one claw 91 for clamping a wheel rim 70. The chuck seat 80 may have a linkage unit 81 mounted therein. The linkage unit 81 is driven by a chuck wrench to slide the soft jaws 90 simultaneously, whereby the wheel rim 70 can be self-aligned with the center of the chuck seat 80 while being clamped.

The claw 91 of the conventional soft jaw 90 substantially has a protrusion 911 and a clamping groove 912. The protrusion 911 protrudes from the top surface 92 of the soft jaw 90. The clamping groove 912 is recessed in a side of the protrusion 911 facing the center of the chuck seat 80. The clamping groove 912 has a side wall 913 and a bottom wall 914. The bottom wall 914 is located above the top surface 92 of the soft jaw 90, and a step 915 is formed between the bottom wall 914 and the top surface 92. To clamp the wheel rim 70, an end of the wheel rim 70 is placed on the steps 915 of the claws 91. The wheel rim 70 will be slid into the clamping grooves 912 with inward sliding movements of the soft jaws 90 and will be clamped by the side walls 913 and the bottom walls 914 of the clamping grooves 912.

However, the bottom wall 914 of each clamping groove 912 has a small area and a step 915 is formed between the bottom wall 914 of the clamping groove 912 and the top surface 92 of the soft jaw 90. When the soft jaws 90 are sliding simultaneously, the wheel rim 70 will drop from the steps 915 to the top surfaces 92 of the soft jaws 90 easily, or will be engaged in the clamping groove 912 of only a single one of the soft jaws 90. The placed position of the wheel rim 70 needs to be adjusted repeatedly until all of the soft jaws 90 clamp the wheel rim 70.

To overcome the shortcomings, the present invention tends to provide a wheel rim chuck with soft jaws to mitigate or obviate the aforementioned problems.

### SUMMARY OF THE INVENTION

The main objective of the invention is to provide a wheel rim chuck with soft jaws, and a wheel rim may be self-slid into the clamping grooves of the soft jaws with sliding movements of the soft jaws without adjusting position. Therefore, the wheel rim chuck with soft jaws can clamp and fix the wheel rim rapidly.

A wheel rim chuck with soft jaws has a chuck seat and multiple soft jaws. The chuck seat has a base seat and multiple sliding seats. The base seat has multiple slide recesses arranged around the center of the base seat at equiangular intervals and radially recessed in the base seat. Each slide recess has an opening formed in an end surface of the base seat. The sliding seats are mounted slidably in the slide recesses.

The soft jaws are respectively mounted on the sliding seats, and protrude from the end surface of the base seat. Each soft jaw has a claw. The claw has a protrusion, a clamping groove, and an incline plane. The protrusion protrudes from a side of the soft jaw away from the end surface of the base seat. The clamping groove is recessed in a side of the protrusion facing the center of the base seat and has a side wall formed in the side of the protrusion facing the center of the base seat and a bottom wall connected with an end of the side wall near the chuck seat. The inclined plane extends longitudinally and obliquely from the bottom wall of the clamping groove away from the side wall of the clamping groove.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a wheel rim chuck with soft jaws in accordance with the present invention;

FIG. 2 is a side view in partial section of the wheel rim chuck in FIG. 1;

FIG. 2A is an enlarged cross sectional side view of the wheel rim chuck in FIG. 2;

FIG. 3 is a top view in partial section of the wheel rim chuck in FIG. 1;

FIG. 3A is an enlarged top view in partial section of the wheel rim chuck in FIG. 3;

FIG. 4 is an operational side view of the wheel rim chuck in FIG. 1 showing a wheel rim being placed on the inclined planes of the soft jaws;

FIG. 5 is an operational side view in partial section of the wheel rim chuck in FIG. 1, showing the wheel rim being engaged with the clamping grooves;

FIG. 5A is an enlarged operational cross sectional side view of the wheel rim chuck in FIG. 5;

FIG. 6 is an operational top view in partial section of the wheel rim chuck in FIG. 5;

FIG. 6A is an enlarged operational top view in partial section of the wheel rim chuck in FIG. 6;

FIG. 7 is a perspective view of the wheel rim chuck in FIG. 1, shown mounted on a rim trimming machine;

FIG. 8 is a perspective view of the wheel rim chuck in FIG. 1, shown mounted on a vertical machine tool;

FIG. 9 is a perspective view of a conventional chuck for clamping a wheel rim; and

FIG. 10 is an operational side view of the conventional chuck in FIG. 9.

### DETAILED DESCRIPTION OF PREFERRED EMBODIMENT

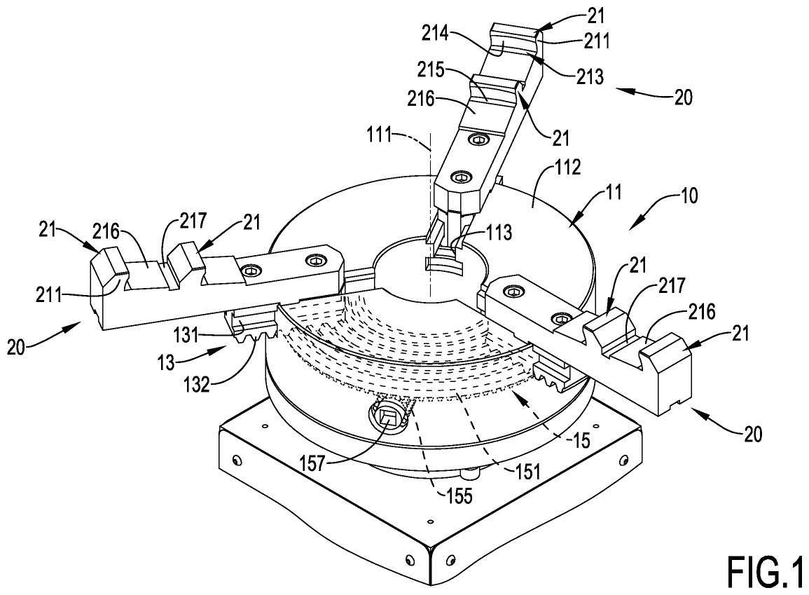

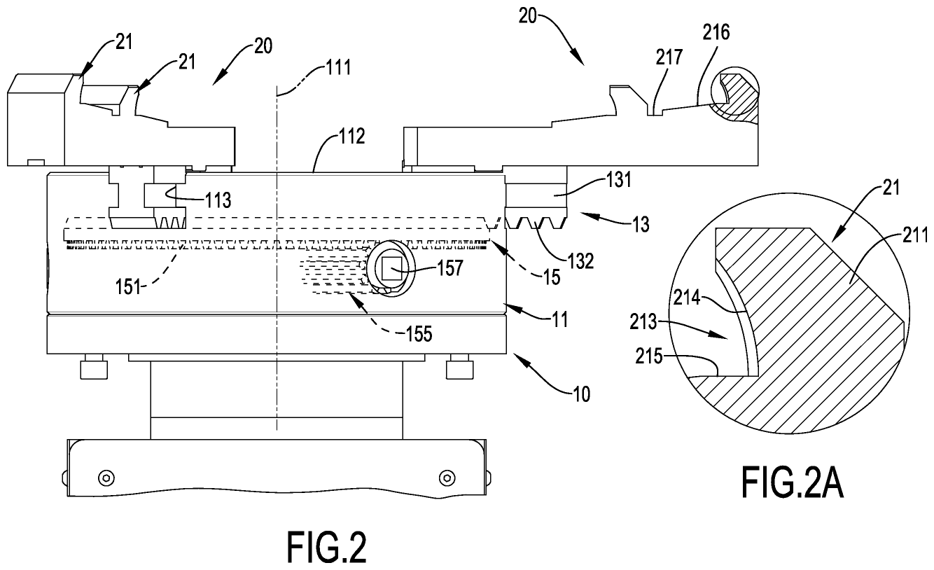

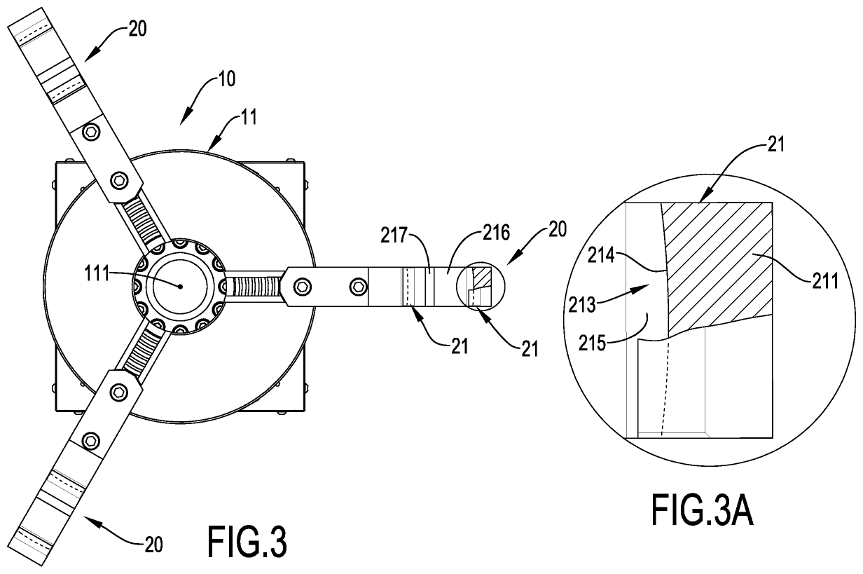

With reference to FIGS. 1 to 3, a wheel rim chuck with soft jaws in accordance with the present invention has a chuck seat 10 and multiple soft jaws 20. The chuck seat 10 substantially has a base seat 11, multiple sliding seats 13 and a linkage unit 15. The base seat 11 has a center 111 and multiple slide recesses 113. The slide recesses 113 are arranged radially around the center 111 of the base seat 11 at equiangular intervals and are radially recessed in the base seat 11. The end section of each slide recess 133 is I-shaped. Each slide recess 113 has an opening formed in the end surface 112 of the base seat 11. The sliding seats 13 are respectively mounted in the slide recesses 113 and are slidable along the slide recesses 113 respectively. Each sliding seat 13 has a sliding portion 131 corresponding to the respective one of the slide recesses 113 in end section shape.

The linkage unit 15 is mounted in the base seat 11, is connected with the sliding seats 13 to slide the sliding seats 13 along the slide recesses 113 simultaneously. The linkage unit 15 may be conventional, and the detail thereof is omitted. The linkage unit 15 substantially has a linkage component 151 and a driving component 155. The linkage component 151 is connected with the sliding seats 13, and each sliding seat 13 has an engagement portion 132 engaged with the linkage component 151. The driving component 155 is engaged with the linkage component 151 and may have a key hole 157 recessed therein for insertion of a chuck wrench. The linkage unit 15 may be driven by the chuck wrench to slide the sliding seats 13 along the slide recesses 113 at the same time. The driving component 155 may also be connected with a driving unit for driving the linkage unit 15.

The amount of the soft jaws 20 is same as the amount of the sliding seats 13. The soft jaws 20 are respectively detachably mounted on the sliding seats 13, protrude from the end surface 112 of the base seat 11, and are moved with the sliding seats 13. Each soft jaw 20 has a longitudinal direction parallel to the corresponding one of the slide recesses 113 and a claw 21. The claws 21 of the soft jaws 20 correspond to each other in position for clamping a wheel rim. Each soft jaw 20 may have multiple said claws 21 arranged along the longitudinal direction of the soft jaw 20 at spaced intervals for clamping wheel rims in different sizes. Each soft jaw 20 may be made of aluminum alloy or other metal having a lower hardness than the wheel rim to prevent the wheel rim from being damaged while clamping.

Each claw 21 has a protrusion 211, a clamping groove 213 and an inclined plane 216. The protrusion 211 protrudes from a side of the soft jaw 20 away from the end surface 112 of the base seat 11. The clamping groove 213 is recessed in a side of the protrusion 211 facing the center 111 of the base seat 11 and has a side wall 214 and a bottom wall 215. The side wall 214 is formed in the side of the protrusion 211 facing the center 111 of the base seat 11. The side wall 214 is a concave surface which has a large contact area with the wheel rim. The bottom wall 215 is a plane and is connected with an end of the side wall 214 near the chuck seat 10. The inclined plane 216 extends longitudinally and obliquely from the bottom wall 215 away from the side wall 214. A distance from the end of the inclined plane 216 near the bottom wall 215 to the end surface 112 of the base seat 11 is larger than a distance from the end of the inclined plane 216 away from the bottom wall 215 to the end surface 112 of the base seat 11. A cavity 217 is recessed in the claw 21 in the end of the inclined plane 216 away from the bottom wall 215.

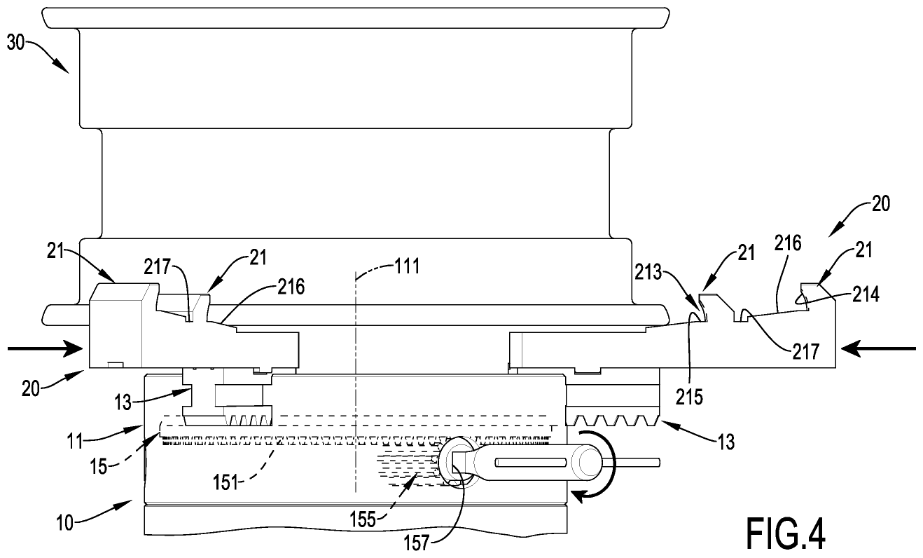

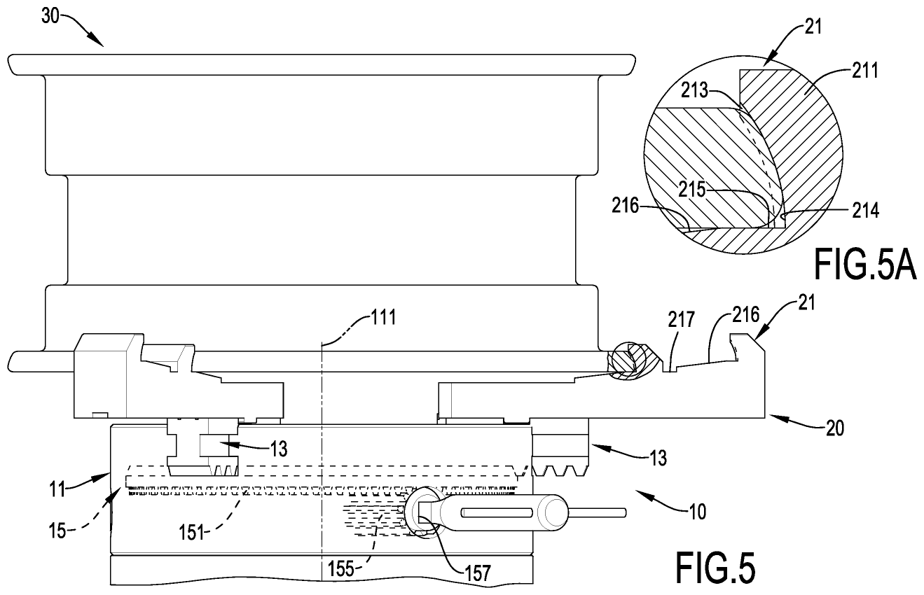

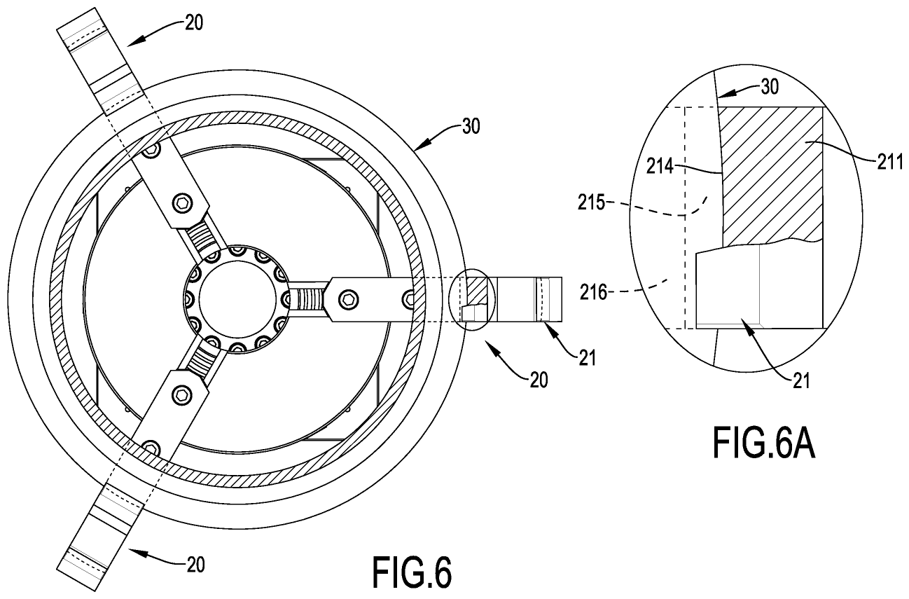

With reference to FIGS. 4 to 6, to clamp a wheel rim 30, the wheel rim 30 is placed on the inclined planes 216 of corresponding claws 21 of the soft jaws 20. Then, the linkage unit 15 is driven by a chuck wrench or a driving unit, and the soft jaws 20 are slid toward the center 111 simultaneously by the linkage unit 15. When the soft jaws 20 are sliding, the wheel rim 30 will be slid along the inclined planes 216 of the claws 21 onto the bottom walls 215 of the clamping grooves 213 to engage in the clamping grooves 213 and to be clamped by the side walls 214 and the bottom walls 215 of the clamping grooves 213. Because the side wall 214 of each claw 21 is a concave surface, the clamping grooves 213 may be engaged with the flange of the wheel rim 30 with a larger contact area to clamp the wheel rim 30 stably. Moreover, the chuck seat 10 has the linkage unit 15 to simultaneously slide the soft jaws 20, so the wheel rim 30 may be self-aligned with the center 111 of the base seat 11 with the soft jaws 20. The clamping process is simplified and the wheel rim 30 can be clamped and fixed rapidly.

The sliding seats 13 of the chuck seat 10 may also be mounted in the base seat 11 without the linkage unit 15, and each sliding seat 13 is moved independently. The wheel rim 30 will be slid along the inclined plane 216 of the soft jaw 20 into the clamping groove 213 while a respective one of the soft jaws 20 sliding inward. The clamping process is simplified without adjusting the position of the wheel rim 30.

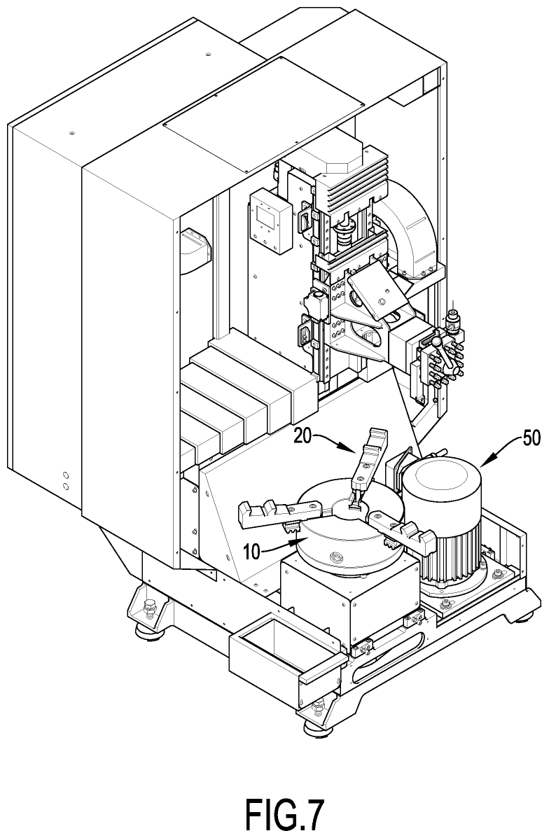

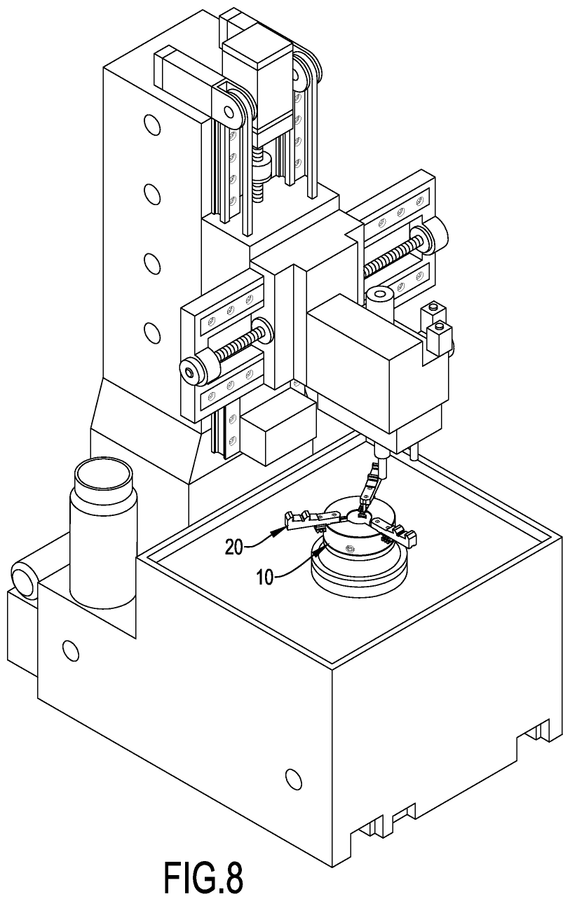

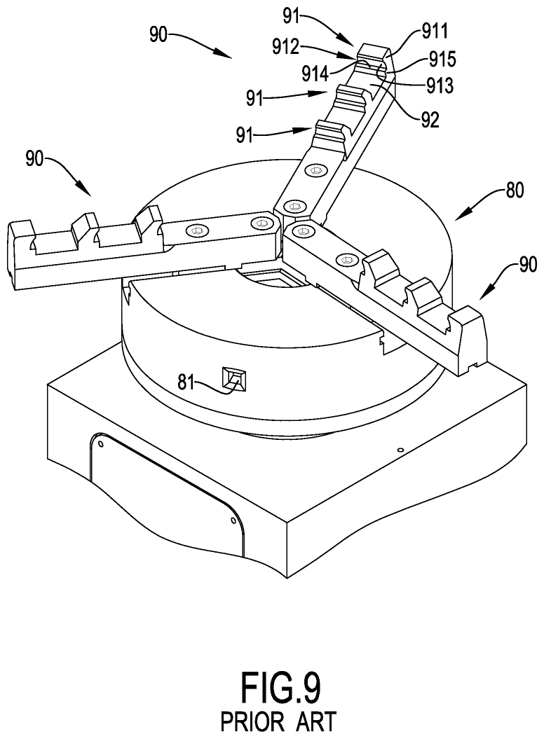

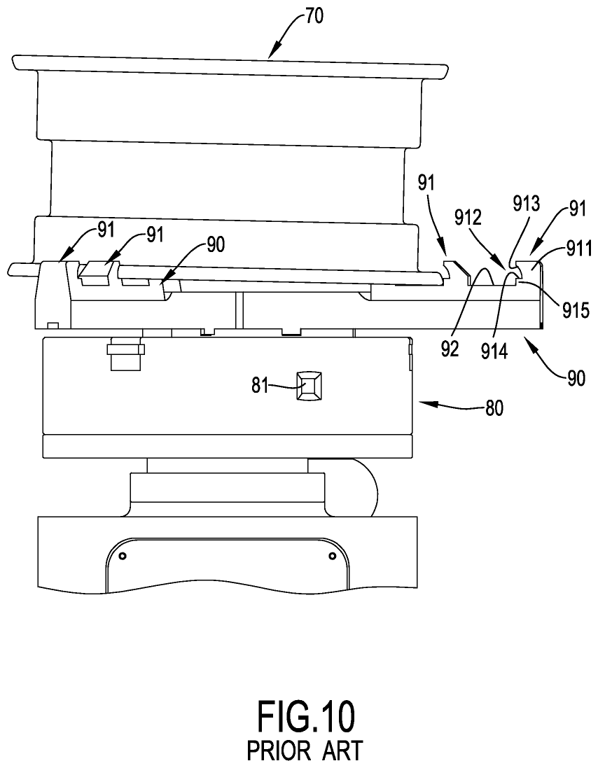

The wheel rim chuck with soft jaws in accordance with the present invention may be mounted on a rim trimming machine as shown in FIG. 7. The chuck seat 10 is connected to a motor 50 through a transmission member. The chuck seat 10 may be rotated by the motor 50 to provide a rotating wheel rim for trimming. The wheel rim chuck with soft jaws in accordance with the present invention may be mounted on a vertical machine tool as shown in FIG. 8, to clamp and fix a wheel rim for drilling or milling

What is claimed is:

1. A wheel rim chuck comprising:
a chuck seat having;
a base seat having;
a center;
an end surface; and
multiple slide recesses arranged around the center of the base seat at equiangular intervals and radially recessed in the base seat, and each slide recess having an opening formed in the end surface of the base seat; and
multiple sliding seats respectively mounted slidably in the slide recesses; and
multiple soft jaws respectively mounted on the sliding seats and protruding from the end surface of the base seat, and each soft jaw having
a claw having
a protrusion protruding from a side of the soft jaw away from the end surface of the base seat;
a clamping groove recessed in a side of the protrusion facing the center of the base seat and having
a side wall formed in the side of the protrusion facing the center of the base seat; and
a bottom wall connected with an end of the side wall near the chuck seat; and
an inclined plane extending longitudinally and obliquely from the bottom wall of the clamping groove away from the side wall of the clamping groove.

2. The wheel rim chuck as claimed in claim 1, wherein a distance from an end of the inclined plane of the claw of each soft jaw near the bottom wall of the claw of the soft jaw to the end surface of the base seat is larger than a distance from an end of the inclined plane of the claw of each soft jaw away from the bottom wall of the claw of the soft jaw to the end surface of the base seat.

3. The wheel rim chuck as claimed in claim 2, wherein the sidewall of the clamping groove of the claw of each soft jaw is a concave surface.

4. The wheel rim chuck as claimed in claim 3, wherein a cavity is recessed in the claw in the end of the inclined plane of the claw of each soft jaw away from the bottom wall of the claw of the soft jaw.

5. The wheel rim chuck as claimed in claim 4, wherein the chuck seat further has a linkage unit mounted in the base seat and connected with the sliding seats.

6. The wheel rim chuck as claimed in claim 1, wherein each soft jaw has multiple said claws, and the claws of each soft jaw are arranged longitudinally at spaced intervals.

7. The wheel rim chuck as claimed in claim 2, wherein each soft jaw has multiple said claws, and the claws of each soft jaw are arranged longitudinally at spaced intervals.

8. The wheel rim chuck as claimed in claim 3, wherein each soft jaw has multiple said claws, and the claws of each soft jaw are arranged longitudinally at spaced intervals.

9. The wheel rim chuck claimed in claim 4, wherein each soft jaw has multiple said claws, and the claws of each soft jaw are arranged longitudinally at spaced intervals.

10. The wheel rim chuck claimed in claim 5, wherein each soft jaw has multiple said claws, and the claws of each soft jaw are arranged longitudinally at spaced intervals.
